(19) United States
(12) Patent Application Publication
(10) Pub. No.: US 2007/0064153 A1
(43) Pub. Date: Mar. 22, 2007

(54) Information processing apparatus capable of receiving broadcast program data, and method of controlling power savings which is applied to the apparatus

(75) Inventors: Mitsunhiko Obara, Fussa-shi (JP); Toshikazu Mukaiyama, Nishitama-gun (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/508,520

(22) Filed: Aug. 22, 2006

(30) Foreign Application Priority Data
Sep. 21, 2005 (JP) 2005-273796

(51) Int. Cl. H04N 3/27; H04N 5/63

(52) U.S. Cl. 348/554; 348/730

(57) ABSTRACT

According to one embodiment, a receiving unit includes a tuner unit, an analog demodulation unit, a digital demodulation unit, an analog television processing unit, a digital television processing unit and a bus interface unit. A control unit sets a unit of the units included in the receiving unit, which is unnecessary for execution of the television application program, in a power-saving state according to an execution state of the television application program.

### CROSS-REFERENCE TO RELATED APPLICATIONS

This application is based upon and claims the benefit of priority from Japanese Patent Application No. 2005-273796, filed Sep. 21, 2005, the entire contents of which are incorporated herein by reference.

### BACKGROUND

1. Field

One embodiment of the invention relates to an information processing apparatus such as a personal computer and, more specifically, to an information processing apparatus capable of receiving both analog broadcast program data and digital broadcast program data and a method of controlling power savings which is applied to the apparatus.

2. Description of the Related Art

Conventionally, various battery-operable portable personal computers such as notebook personal computers have been developed. Recently, portable personal computers incorporating a receiving unit for receiving broadcast program data such as a television (TV) tuner/capture unit have been developed. A receiving unit of this type is required to have a function of receiving both analog broadcast program data and digital broadcast program data in accordance with digitization of broadcasting.

In general, a personal computer capable of receiving both analog broadcast program data and digital broadcast program data includes an analog TV tuner circuit/demodulation circuit (analog TV capture unit) and a digital TV tuner circuit/demodulation circuit (digital TV capture unit) independently of each other. The analog and digital TV demodulation circuits are independently connected to a system bus. The personal computer requires two tuner circuits and two system bus interface circuits. However, these circuits are difficult to incorporate in a portable personal computer because they occupy the computer disadvantageously. The power consumption of a receiving unit including an analog TV tuner/capture unit and a digital TV tuner/capture unit independently of each other is almost two times as high as that of a receiving unit having one of analog and digital TV tuner/capture units. In this case, a time period for which a portable personal computer can be driven by a battery (battery-driving time) is shortened.

For example, Jpn. Pat. Appln. KOKAI Publication No. 8-289212 discloses a digital/analog shared tuner capable of receiving both analog broadcast program data and digital broadcast program data. The shared tuner includes an independent demodulation circuit for both analog TV and digital TV. With the technique (prior art) disclosed in the Publication, one tuner (digital/analog shared tuner) can receive both analog broadcast program data and digital broadcast program data.

However, the above prior art necessitates a system bus interface circuit for each of analog and digital TV demodulation circuits included in the digital/analog shared tuner. In the prior art, therefore, it still difficult to incorporate a receiving unit including a digital/analog shared tuner in an information processing apparatus such as a portable computer. The prior art does not necessarily consider power savings of a receiving unit. In general, when a personal computer starts up, a power supply voltage is applied to a receiving unit of the personal computer. A portable personal computer incorporating a receiving unit having a digital/analog shared tuner increases in power consumption by the amount of power consumed by the receiving unit. Even though the personal computer does not record or reproduce TV broadcast program data, its battery-driving time is shortened.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of an exemplary outward appearance of a personal computer according to an embodiment of the invention;

FIG. 2 is a block diagram of an exemplary system configuration of the personal computer shown in FIG. 1;

FIG. 3 is a block diagram of an exemplary configuration of a TV tuner/capture unit shown in FIG. 2;

FIG. 4 is a table showing an exemplary relationship between bits of a control register and each of states of a tuner-on signal, analog TV mode signals, and digital TV mode signals, which is applied to the embodiment of the invention;

FIGS. 5A and 5B are flowcharts showing an exemplary procedure for power-saving control applied to the embodiment of the invention;

FIG. 6 is a flowchart showing an exemplary procedure for analog TV processing; and

FIG. 7 is a flowchart showing an exemplary procedure for digital TV processing.

### DETAILED DESCRIPTION

Various embodiments according to the invention will be described hereinafter with reference to the accompanying drawings. In general, according to one embodiment of the invention, there is provided an information processing apparatus which has a bus used to transfer various items of data including video data reproduced by execution of a television application program that supports both an analog television mode and a digital television mode and which allows data transferred via the bus to be displayed on a display device. The apparatus comprises a receiving unit and a control unit. The receiving unit is configured to receive both analog broadcast program data and digital broadcast program data. The receiving unit includes a digital/analog shared tuner unit configured to convert a radio-frequency signal, which is generated by mixing an analog-modulated television signal and a digital-modulated television signal together, into an intermediate frequency signal, an analog demodulation unit configured to demodulate the intermediate frequency signal output from the tuner unit and generate data of a first format in the analog television mode, a digital demodulation unit configured to demodulate the intermediate frequency signal output from the tuner unit and generate data of a second format in the digital television mode, an analog television processing unit configured to subject the data of the first format to a process proper thereto and output analog television data, a digital television processing unit configured to subject the data of the second format to a process proper thereto and output digital television data, and a bus interface unit configured to connect the bus to the analog television processing unit and the digital television processing unit. The control unit is configured to set a unit that is unnecessary for execution of the television application program in a power-saving state according to an execution state of the television application program. The unit is one of the tuner unit, the analog demodulation unit, the digital demodulation unit, the analog television processing unit, and the digital television processing unit included in the receiving unit.

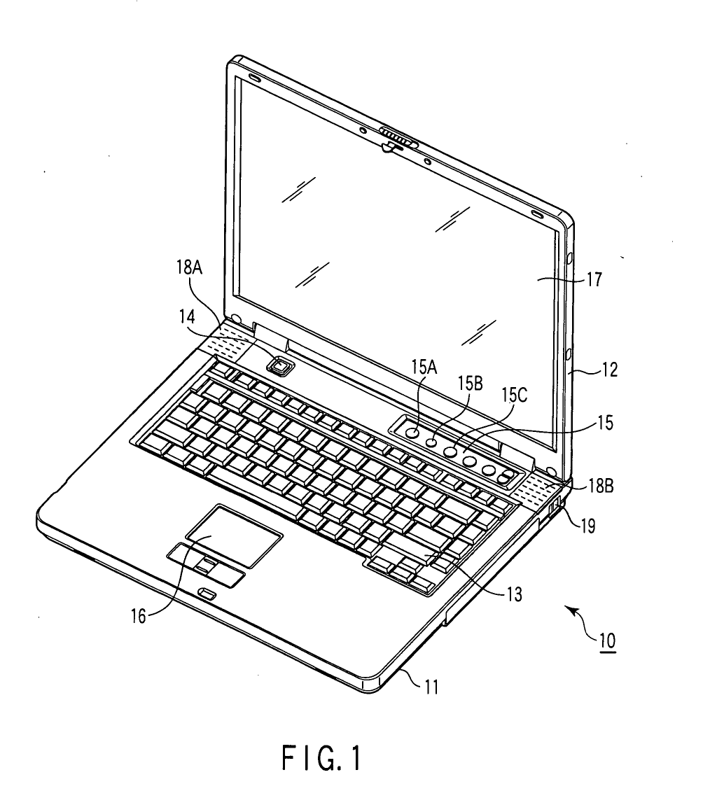

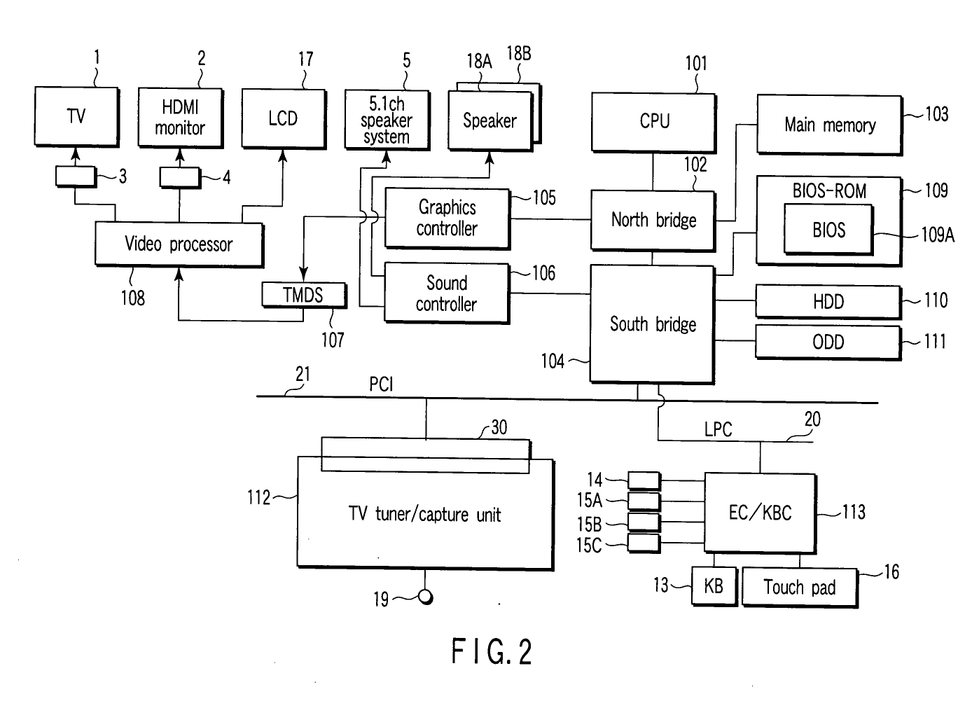

The configuration of an information processing apparatus according to an embodiment of the invention will be described with reference to FIGS. 1 and 2. The information processing apparatus is implemented as, for example, a notebook personal computer 10. FIG. 1 is a perspective view of the notebook personal computer 10 whose display unit is open. The computer 10 includes a main body 11 and a display unit 12. The display unit 12 incorporates a display device that is formed of a liquid crystal display (LCD) 17. The display screen of the LCD 17 is located in almost the central part of the display unit 112. The display unit 12 is attached to the main body 11 such that it can turn between its open position and closed position. The main body 11 has a thin box-shaped housing. A keyboard 13, a power button 14, an input operation panel 15, a touch pad 16 and speakers 18A and 18B are arranged on the top surface of the main body 11. The power button 14 is used to power on/power off the computer 10.

The input operation panel 15 is an input device for inputting an event corresponding to a depressed button. The panel 15 includes a plurality of buttons for starting their respective functions. These buttons include an analog TV start button 15A, a digital TV start button 15B and a channel selection button 15C. The TV start buttons 15A and 15B are used to start a TV function of reproducing analog TV broadcast program data and digital TV broadcast program data.

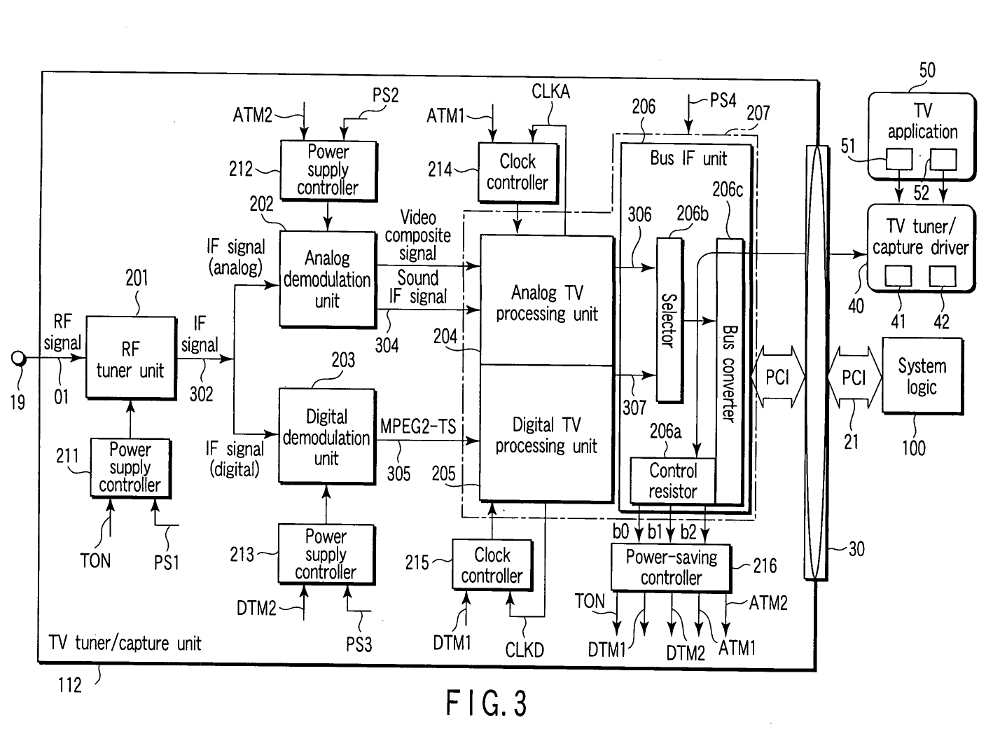

When a user depresses the TV start button 15A or 15B, a TV application (TV application program) 50 (FIG. 3) starts automatically. A process for reproducing the analog TV broadcast program data or digital TV broadcast program data is thus performed. In other words, the TV application 50 supports reproduction of the analog TV broadcast program data and digital TV broadcast program data (analog TV mode and digital TV mode). The TV application 50 is a video reproduction program for reproducing and recording TV broadcast program data and for doing video data (audio/video data) supplied from an external device (external audio/video equipment).

When a user depresses the TV start button 15A while the TV application 50 is reproducing digital TV broadcast program data, the process of the TV application 50 is switched to the reproduction of analog TV broadcast program data. Similarly, when the user depresses the TV start button 15B while the TV application 50 is reproducing analog TV broadcast program data, the process of the TV application 50 is switched to the reproduction of digital TV broadcast program data. The channel selection button 15C is used to select a channel for TV broadcast program data to be reproduced (viewed and heard)/recorded. Whenever the user depresses the channel selection button 15C, the channels for TB broadcast program data to be reproduced/recorded are selected in sequence.

The computer 10 is installed with a sub-operating system exclusively for processing audio/video (AV) data as well as a general-purpose main operating system. The TV application program 50 is a program that runs on the sub-operating system. When the user depresses the power button 14, the main operating system starts. When the user depresses the TV start button 15A or 15B, not the main operating system but the sub-operating system starts. As the sub-operating system starts, the TV application program 50 is automatically executed. The sub-operating system has only the minimum function of carrying out an AV function. Thus, a time period required for booting up the sub-operating system is much shorter than that required for booting up the main operating system. The user can thus view/record a TV program promptly by simply depressing the TV start button 15A or 15B.

The computer 10 can receive and reproduce both program data of analog TV broadcast (e.g., terrestrial analog TV broadcast) and that of digital TV broadcast (e.g., terrestrial digital TV broadcast). An antenna terminal 19 common to analog TV broadcast and digital TV broadcast is provided on the right side of the main body 11 of the computer 10. The antenna terminal 19 is supplied with a radio-frequency signal (RF signal) 301 (FIG. 3) through an antenna cable. The RF signal is generated by mixing an analog-modulated TV signal and a digital-modulated TV signal together.

FIG. 2 is a block diagram showing an exemplary system configuration of the computer 10. As shown in FIG. 2, the computer 10 includes a CPU 101, a north bridge 102, a main memory 103, a south bridge 104, a graphics controller 105, a sound controller 106, a transition minimized differential signaling (TMDS) circuit 107, a video processor 108, a BIOS-ROM 109, a hard disk drive (HDD) 110, an optical disk drive (ODD) 111, a TV tuner/capture unit 112 and an embedded controller/keyboard controller IC (EC/KBC) 113.

The CPU 101 is a processor for controlling the operation of the computer 10. The CPU 101 executes the main operating system/sub-operating system and various application programs such as the TV application 50. These main operating system/sub-operating system and application programs are loaded into the main memory 103 from the HDD 110. The CPU 101 also executes a basic input output system (BIOS) 109a stored in the BIOS-ROM 109. The BIOS 109a is a program for control of hardware.

An operating system has a window system for displaying a plurality of windows on a display screen. Video data (e.g., TV broadcast program data, video data supplied from an external device) is usually displayed within a window corresponding to the TV application 50. For example, the window corresponding to the TV application 50 is placed on the desktop, and video data is displayed within the window (window mode). In the computer 10, video data can be displayed on the display screen of the LCD 17 in full-screen mode. In full-screen mode, only video data is displayed in almost all the area of the display screen.

The north bridge 102 is a bridge device for connecting a local bus of the CPU 101 and the south bridge 104. The north bridge 102 incorporates a memory controller for controlling access to the main memory 103. The north bridge 102 has a function of communicating with the graphics controller 105 via an accelerated graphics port (AGP) bus, a serial bus of the PCI express standard, and the like.

The graphics controller 105 is a display controller for controlling the LCD 17 that is used as a display monitor of the computer 10. The video data generated by the graphics controller 105 is transmitted to the video processor 108 via the TMDS circuit 107. The video processor 108 performs a video process (image-quality control process) for improving the image quality of video data transmitted from the graphics controller 105. The video data whose image quality is improved by the video processor 108 can be sent out to an external television (TV) set 1 and an external high-definition multimedia interface (HDMI) monitor 2 via a TV interface (TV-IF) 3 and an HDMI interface (HDMI-IF) 4, respectively.

The south bridge 104 controls devices on a Low Pin Count (LPC) bus. The south bridge 104 incorporates an Integrated Drive Electronics (IDE) controller for controlling the HDD 110 and ODD 111. The south bridge 104 communicates with the sound controller 106. The sound controller 106 is a sound source device, and supplies audio data to be reproduced to the speakers 18A and 18B or an external 5.1-channel speaker system. The speakers 18A and 18B compose a 2-channel speaker system. Further the south bridge 104 controls the BIOS-ROM 109 and devices on a Peripheral Component Interconnect (PCI) bus 21. The PCI bus 21 is used as a system bus. The TV tuner/capture unit 112 is connected to the PCI bus 21 through a bus connector 30. The bus connector 30 is formed of, e.g. a Mini PCI connector.

The TV tuner/capture unit 112 is a receiving unit for receiving program data of analog broadcast such as terrestrial analog TV broadcast and that of digital broadcast such as terrestrial digital TV broadcast. The unit 112 is connected to the antenna terminal 19. The unit 112 receives and processes analog or digital broadcast program data and outputs it onto the PCI bus 21. The TV application 50 displays the data output onto the PCI bus 21 on the LCD 17. The TV application 50 can also perform a recording process to store the data in the HDD 110.

The EC/KBC 113 is a one-chip microcomputer on which an embedded controller (EC) for managing power and a keyboard controller (KBC) for controlling the keyboard (KB) 13 and the touch pad 16 are integrated. The EC/KBC 113 has a function of powering on/powering off the computer 10 in accordance with a user's depression of the power button 14. The EC/KBC 117 has another function of powering on the computer 10 in accordance with a user's depression of the TV start button 15A or 15B.

FIG. 3 is a block diagram of an exemplary configuration of the TV tuner/capture unit 112 shown in FIG. 2. Referring to FIG. 3, the unit 112 is connected to a system logic 100 of the computer 10 via the bus connector 30 and PCI bus 21. The system logic 100 serves as a host system of the unit 112. The system logic 100 includes the CPU 101, north bridge 102, main memory 103, south bridge 104, graphics controller 105, BIOS-ROM 109, HDD 110, ODD 111 and EC/KBC 113 illustrated in FIG. 2.

The TV application 50 includes a start/end notification module 51 and a TV mode designation module 52. The module 51 notifies a TV tuner/capture driver 40 that the TV application 50 has started. The module 52 designates an analog TV mode or a digital TV mode according to a user's operation.

The TV tuner/capture driver 40 is a control unit for controlling the TV tuner/capture unit 112. The driver 40 manages the operating states of the unit 112. The driver 40 is implemented by the CPU 101 to execute a given TV tuner/capture driver program (control program). The process of the driver 40 can thus be treated as that of the CPU 101.

The TV tuner/capture driver 40 includes a power-saving control module 41 and a TV mode control module 42. The module 41 sets power-saving control bit b0 (described later) of a control register 206a of the TV tuner/capture unit 112 to “1” as the TV tuner/capture driver 40 starts. The module 42 detects the analog or digital TV mode designated by the TV mode designation module 52 of the TV application 50 and sets analog TV mode bit b1 and digital TV mode bit b2 (both described later) of the control register 206a to “b1b2=10” or “b1b2 =01”.

The TV tuner/capture unit 112 includes an RF tuner unit 201, an analog demodulation unit 202, a digital demodulation unit 203, an analog TV processing unit 204, a digital TV processing unit 205, a bus interface unit (bus IF unit) 206, power supply controllers 211, 212 and 213, clock controllers 214 and 215 and a power-saving controller 216. In the embodiment of the invention, the analog TV processing unit 204, digital TV processing unit 205 and bus IF unit 206 are integrated on (included in) a one-chip LSI 207. A power supply voltage PS4 is applied to the LSI 207 as the computer 10 is powered on. The power supply voltage PS4 is used as one common to the units 204, 205 and 206 integrated on the LSI 207. The bus IF unit 206 need not be included in the LSI 207. Each of the units 204 and 205 can be provided as an independent LSI.

The RF tuner unit 201 is a digital/analog shared tuner as disclosed in the Publication described above. The RF tuner unit 201 can be operated by a power supply voltage PS1 applied thereto. The unit 201 is connected to the antenna terminal 19. The unit 201 receives an RF signal 301 via the antenna terminal 19. As described above, the RF signal 301 is generated by mixing an analog-modulated TV signal and a digital-modulated TV signal together. The unit 201 selects, from the received RF signal 301, a signal of a band corresponding to a channel selected by a user and amplifies the selected signal. The unit 201 converts the amplified signal into an intermediate frequency (IF) signal. The unit 201 eliminates an undesired frequency component from the IF signal using a surface acoustic wave (SAW) filter as a band-pass filter. The unit 201 outputs the IF signal whose undesired frequency component has been eliminated as an IF signal 302.

The analog demodulation unit 202 can be operated in analog TV mode. The unit 202 demodulates the IF signal 302 output from the RF tuner unit 201. Thus, the unit 202 generates a video signal (video composite signal) 303 of a composite signal (TV-CVBS) type and an audio signal (sound IF signal) 304 of a second sound intermediate frequency (2nd SIF) type.

The digital demodulation unit 203 can be operated in digital TV mode. The unit 203 demodulates the IF signal 302 output from the RF tuner unit 201 and generates a transport stream (TS) 305 including broadcast program data (video data, audio data). In the terrestrial digital TV broadcasting, Moving Picture Experts Group 2 (MPEG2) is used as a method of compressing and encoding broadcast program data (broadcast content). The TS 305 is therefore represented as MPEG2-TS 305. The MPEG2-TS 305 is composed of a plurality of continuous TS packets. Each of the TS packets includes a header and a payload.

The analog TV processing unit 204 can be operated in analog TV mode. The unit 204 performs a video decoding process and a sound decoding process for decoding the video composite signal 303 and sound IF signal 304, respectively, which are output from the analog demodulation unit 202. Thus, the unit 204 generates, for example, digital video data of ITU-656 format and digital audio data of I2S format. The unit 204 compresses and encodes the digital video data and digital audio data into an AV stream by a compression encoding method such as the MPEG2. The unit 204 outputs the AV stream (video data and audio data of a given format) as analog TV data 306. The analog TV data 306 is sent to the bus IF unit 206.

The digital TV processing unit 205 can be operated in digital TV mode. The unit 205 temporarily buffers the MPEG2-TS 305. The unit 205 performs a process of separating the encoded video and sound data, called a packetized elementary stream (PES) packet, from the MPEG2-TS 305. The unit 205 outputs the separated video and sound data as digital TV data 307. The digital TV data 307 is sent to the bus IF unit 206.

The bus IF unit 206 is a PCI device that communicates with the system logic 100 via the bus connector 30 and PCI bus 21. The bus IF unit 206 includes a control register 206a, a selector 206b and a bus converter (interface converter) 206c. The control register 206a is used to hold control information for controlling the power-saving states (operable states) of the RF tuner unit 201, analog demodulation unit 202, digital demodulation unit 203, analog TV processing unit 204 and digital TV processing unit 205. This control information is composed of, e.g., power-saving control bit b0, analog TV mode bit b1 and digital TV mode bit b2. The control register 206a can be accessed via the TV tuner/capture driver 40.

The selector 206b selects one of the analog TV data 306 output from the analog TV processing unit 204 and the digital TV data 307 output from the digital TV processing unit 205 in accordance with the analog TV mode bit b1 and digital TV mode bit b2 of the control register 206a. The bus converter 206c converts the analog TV data 306 or digital TV data 307 selected by the selector 206b into data (system bus data) of a format that conforms to the PCI bus 21 serving as a system bus. The bus converter 206c transfers the system bus data to the system logic 100 through the bus connector 30 and PCI bus 21.

In response to a tuner-on signal (first control signal) TON, the power supply controller (first controller) 211 determines whether a power supply voltage PS1 is applied to the RF tuner unit 201. In other words, the power supply controller 211 controls the on/off of a power supply voltage PS1 to be applied to the RF tuner unit 201, in response to a tuner-on signal TON. In the embodiment of the invention, the power supply controller 211 turns on the power supply voltage PS1 while TON is “1” and turns it off while TON is “0”. Thus, the power supply voltage PS1 is applied to the RF tuner unit 201 while TON is “1” and it is inhibited from being applied to the unit 201 while TON is “0”. The RF tuner unit 201 is in an operable state while TON is “1” (second logic state), and it is in a nonoperable state (or power-saving state) while TON is “0” (first logic state).

In response to an analog TV mode signal (second control signal) ATM2, the power supply controller (second controller) 212 determines whether a power supply voltage PS2 is applied to the analog demodulation unit 202. In other words, the power supply controller 212 controls the on/off of a power supply voltage PS2 to be applied to the analog demodulation unit 202, in response to an analog TV mode signal ATM2. In the embodiment of the invention, the power supply controller 212 turns on the power supply voltage PS2 while ATM2 is “1” and turns it off while ATM2 is “0”. Thus, the analog demodulation unit 202 is in an operable state while ATM2 is “1” (second logic state), and it is in a nonoperable state (power-saving state) while ATM2 is “0” (first logic state).

In response to a digital TV mode signal (third control signal) DTM2, the power supply controller (third controller) 213 determines whether a power supply voltage PS3 is applied to the digital demodulation unit 203. In other words, the power supply controller 213 controls the on/off of a power supply voltage PS3 to be applied to the digital demodulation unit 203, in response to a digital TV mode signal DTM2. In the embodiment of the invention, the power supply controller 213 turns on the power supply voltage PS3 while DTM2 is “1” and turns it off while DTM2 is “0”. Thus, the digital demodulation unit 203 is in an operable state while DTM2 is “1” (second logic state), and it is in a nonoperable state (power-saving state) while DTM2 is “0” (first logic state).

In response to an analog TV mode signal (fourth control signal) ATM1, the clock controller (fourth controller) 214 masks an analog TV clock signal CLKA necessary for operating the analog TV processing unit 204. The clock controller 214 is a gate circuit that is supplied with an analog TV clock signal CLKA and an analog TV mode signal ATM1. The clock controller 214 permits the output of the analog TV clock signal CLKA to be supplied to the clock controller 214 while ATM1 is “1” and inhibits the output of the clock signal CLKA while ATM1 is “0”. In other words, the clock controller 214 enables the analog TV clock signal CLKA used in the analog TV processing unit 204 while ATM1 is “1” and disables (masks) it while ATM1 is “0”. Thus, the analog TV processing unit 204 is in an operable state while ATM1 is “1” (second logic state), and it is in a nonoperable state (or power-saving state) while ATM1 is “0” (first logic state).

In response to a digital TV mode signal (fifth control signal) DTM1, the clock controller (fifth controller) 215 masks a digital TV clock signal CLKD necessary for operating the digital TV processing unit 205. The clock controller 215 is a gate circuit that is supplied with a digital TV clock signal CLKD and a digital TV mode signal DTM1. The clock controller 215 permits the output of the digital TV clock signal CLKD to be supplied to the clock controller 215 while DTM1 is “1” and inhibits the output of the clock signal CLKD while DTM1 is “0”. In other words, the clock controller 215 enables the digital TV clock signal CLKD used in the digital TV processing unit 205 while DTM1 is “1” and disables (masks) it while DTM1 is “0”. Thus, the digital TV processing unit 205 is in an operable state while DTM1 is “1” (second logic state), and it is in a nonoperable state (power-saving state) while DTM1 is “0” (first logic state).

In the embodiment of the invention, the power-saving states of the analog and digital TV processing units 204 and 205, which are integrated in the one-chip LSI 207, are controlled independently by masking (stopping) the clock signals CLKA and CLKD, as described above. After the personal computer 10 is powered on, a power supply voltage PS4 is applied to the analog TV processing unit 204, digital TV processing unit 205 and bus IF unit 206 in the LSI 207; however, a circuit that is unnecessary for operating the units in the LSI 207 is prevented from consuming power uselessly.

In FIG. 3, the clock controllers 214 and 215 are provided outside the analog and digital TV processing units 204 and 205, respectively for reasons of drawing. In the embodiment of the invention, however, the clock controllers 214 and 215 are incorporated in the analog and digital TV processing units 204 and 205, respectively.

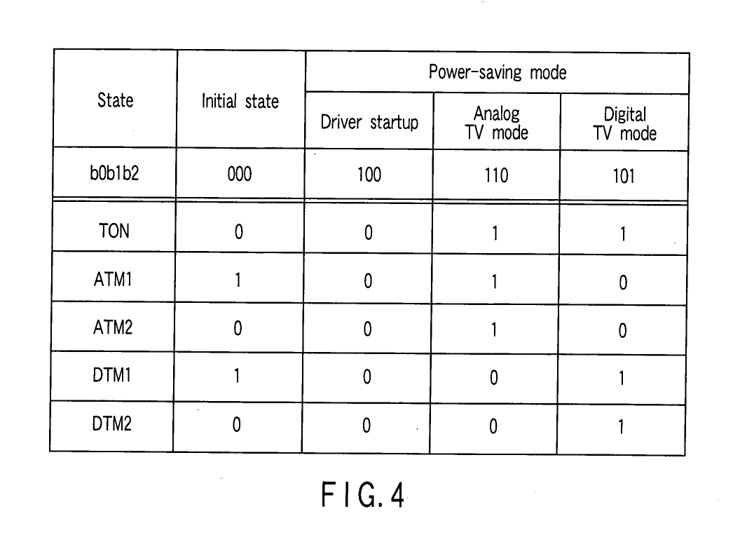

The power-saving controller 216 controls the states of the tuner-on signal TON, analog TV mode signals ATM1 and ATM2 and digital TV mode signals DTM1 and DTM2 in accordance with the logic states of bits b0 to b2 of the control register 206a. FIG. 4 shows a relationship between the bits b0 to b2 of the control register 206a and the states of the tuner-on signal TON, analog TV mode signals ATM1 and ATM2 and digital TV mode signals DTM1 and DTM2.

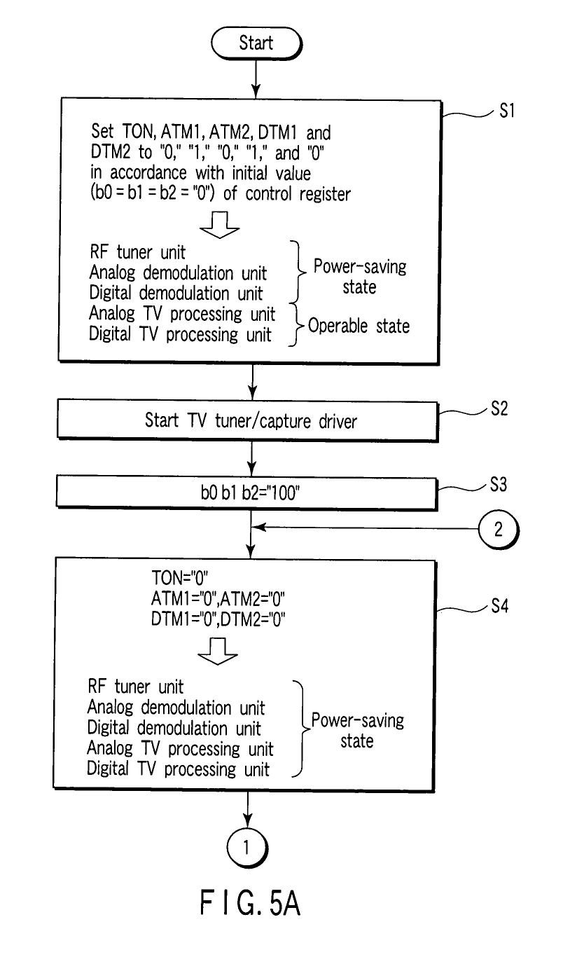

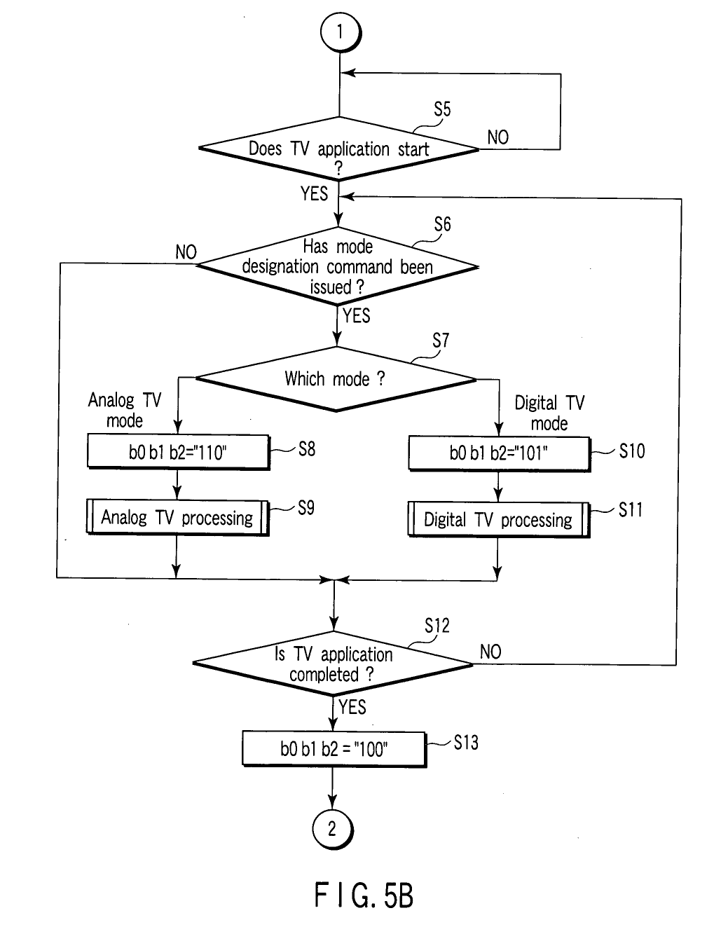

A procedure for performing a power-saving process (power-saving control process) of the TV tuner/capture unit 112 in the embodiment of the invention will be described with reference to the flowcharts shown in FIGS. 5A, 5B, 6 and 7. Assuming first that the personal computer 10 is powered on, a system power supply voltage PS is applied to the TV tuner/capture unit 112 from a power supply unit in the system logic 100 via the bus connector 30. In the TV tuner/capture unit 112, a power supply circuit (not shown) generates power supply voltages PS1, PS2, PS3 and PS4 from the system power supply voltage PS.

When the system power supply voltage PS is applied to the TV tuner/capture unit 112, the bus IF unit 206 in the unit 112 is reset in terms of hardware. Thus, the power-saving control bit b0, analog TV mode bit b1 and digital TV mode bit 2 of the control register 206a included in the bus IF unit 206 are all reset to “1”.

The power-saving controller 216 sets the states of the tuner-on signal TON, analog TV mode signals ATM1 and ATM2 and digital TV mode signals DTM1 and DTM2 as follows, or as shown in FIG. 4, in accordance with the initial values (b0=b1=b2=“0”) of the control register 206a (block S1 in FIG. 5A):

TON=“0”

ATM1=“1”

ATM2=“0”

DTM1 =“1”

DTM2 =“0”

Then, the power supply controllers 211, 212 and 213 block the power supply voltages PS1, PS2 and PS3 that are to be applied to the RF tuner unit 201, analog demodulation unit 202 and digital demodulation unit 203, respectively. The RF tuner unit 201, analog demodulation unit 202 and digital demodulation unit 203 are set in a power-saving state (nonoperable state). On the other hand, the clock controllers 214 and 215 enable the clock signals CLKA and CLKD that are used in the analog and digital TV processing units 204 and 205. Accordingly, the units 204 and 205 are both set in an operable state. When the control register 206a is initialized, the units 204 and 205 can be set in a power-saving state (nonoperable state) like the units 201, 202 and 203.

Under the above condition, for example, the TV tuner/capture driver 40 is started by the main operating system (block S2 in FIG. 5A). Then, the power-saving control module 41 of the driver 40 sets the power-saving control bit b0 of the control register 206a to “1” (block S3 in FIG. 5A). Consequently, the bits b0, b1 and b2 of the control register 206a are set to “1”, “0” and “0”, respectively. The fact that bit b0 is equal to “1” (b0=1) indicates that the TV tuner/capture unit 112 is set in power-saving control mode. The fact that bit b1 and bit b2 are each equal to “0” (b1=b2=0) indicates that the TV tuner/capture unit 112 is set neither in analog TV mode nor in digital TV mode. In power-saving control mode, of the units 201 to 205 in the TV tuner/capture unit 112, a unit that is unnecessary for executing the TV application program 50 is set in a power-saving state as will be described below.

The power-saving controller 216 sets the states of the tuner-on signal TON, analog TV mode signals ATM1 and ATM2 and digital TV mode signals DTM1 and DTM2 as follows, or as shown in FIG. 4, in accordance with the values of bits b0, b1 and b2 (b0=“1”, b1=“0” and b2=“0”) of the control register 206a (block S4 in FIG. 5A):

TON=“0”

ATM1=“1”

ATM2=“0”

DTM1=“1”

DTM2=“0”

Then, the clock controllers 214 and 215 disable (mask) the analog and digital TV clock signals CLKA and CLKD generated by the analog and digital TV processing units 204 and 205, respectively. The state of each of the units 204 and 205 is changed to a power-saving state (operable state). On the other hand, the power supply controllers 211, 212 and 213 still block the power supply voltages PS1, PS2 and PS3 that are to be applied to the RF tuner unit 201, analog demodulation unit 202 and digital demodulation unit 203, respectively. In other words, the units 201, 202 and 203 are still held (set) in a power-saving state (nonoperable state).

Immediately after the TV tuner/capture driver 40 starts, the TV tuner/capture unit 112 is set in the power-saving control mode only. The RF tuner unit 201, analog demodulation unit 202, digital demodulation unit 203, analog TV processing unit 204 and digital TV processing unit 205 in the TV tuner/capture unit 112 are all set in a power-saving state. Then, the TV tuner/capture unit 112 is held in a state from which the greatest power-saving effect can be obtained. The power consumption of the personal computer 10 under this condition is limited to almost the same as that of a notebook personal computer not including the TV tuner/capture unit 112.

Under the above condition, the TV application 50 does not start or the TV tuner/capture unit 112 is set in neither of the analog and digital TV modes. The RF tuner unit 201, analog demodulation unit 202, digital demodulation unit 203, analog TV processing unit 204 or digital TV processing unit 205 in the TV tuner/capture unit 112 need not operate. In other words, while the TV application 50 is not being executed, these units are unnecessary for executing the TV application 50. No problems therefore occur if all of the units are set in a power-saving state.

The TV mode control module 42 of the TV tuner/capture driver 40 monitors a startup notification from the start/end notification module 51 of the TV application 50 (block S5 in FIG. 5B). When a user depresses the analog TV start button 15A or digital TV start button 15B under this condition, the TV application 50 starts automatically. Then, the startup notification is issued from the start/end notification module 51. When the TV mode control module 42 detects the startup notification (block S5 in FIG. 5B), it waits for a mode designation command for designating the analog TV mode or digital TV mode from the TV mode designation module 52 of the TV application 50 (block S6 in FIG. 5B).

When the user depresses the analog TV start button 15A, the TV application 50 starts and the start/end notification module 51 issues the startup notification. After that, the TV mode designation module 52 issues the mode designation command for designating the analog TV mode. On the other hand, when the user depresses the digital TV start button 15B, the TV application 50 starts and the start/end notification module 51 issues the startup notification. After that, the TV mode designation module 52 issues the mode designation command for designating the digital TV mode. If the user depresses the analog TV start button 15A or digital TV start button 15B during the startup of the TV application 50, the TV mode designation module 52 issues the mode designation command for designating the analog TV mode or digital TV mode. When the TV application 50 starts, the user can select the analog TV mode or digital TV mode from the display screen. The user can select the analog TV mode or digital TV mode using a remote control (not shown).

When the TV mode designation module 52 issues a mode designation command (block S6 in FIG. 5B), the TV mode control module 42 determines a TV mode to be designated by the mode designation command (block S7 in FIG. SB). If the mode designation command designates the analog TV mode, the TV mode control module 42 sets the analog TV mode bit b1 and digital TV mode bit b2 of the control register 206a to “1” and “0”, respectively (block S8 in FIG. 5B). The power-saving control bit b0 is held at “1”. Thus, the TV tuner/capture unit 112 is held in the power-saving control mode. By setting b1 and b2 to “1” and “0” (b1=“1” and b2=“0”), the TV tuner/capture unit 112 is set in the analog TV mode while it is held in the power-saving control mode. Then, the processing in the analog TV mode (analog TV processing) is performed (block S9 in FIG. 5B).

In contrast, if the mode designation command designates the digital TV mode, the TV mode control module 42 sets the power-saving control bits b1 and b2 of the control register 206a to “0” and “1”, respectively (block S10 in FIG. 5B). By setting b1 and b2 to “0” and “1” (b1=“0” and b2=“1”), the TV tuner/capture unit 112 is set in the digital TV mode while it is held in the power-saving control mode. Then, the processing in the digital TV mode (digital TV processing) is performed (block S11 in FIG. 5B).

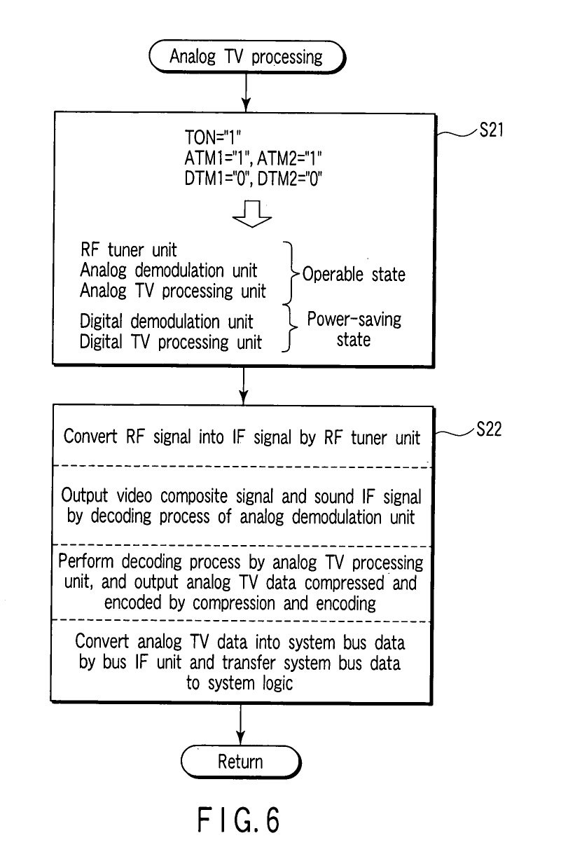

The analog TV processing of block S9 will be described with reference to the flowchart shown in FIG. 6. First, the power-saving controller 216 sets the states of the tuner-on signal TON, analog TV mode signals ATM1 and ATM2 and digital TV mode signals DTM1 and DTM2 as follows, or as shown in FIG. 4, in accordance with the values of bits b0, b1 and b2 (b0=“1”, b1=“1” and b2=“0”) of the control register 206a (block S21 in FIG. 6):

TON=“1”

ATM1=“1”

ATM2=“1”

DTM1=“0”

DTM2=“0”

Then, the power supply controller 211 turns on the power supply voltage PS1 that is to be applied to the RF tuner unit 201, on the basis of TON=“1”. The power supply controller 212 turns on the power supply voltage PS2 that is to be applied to the analog demodulation unit 202, on the basis of ATM2=“1”. The clock controller 214 enables the analog TV clock signal CLKA on the basis of ATM1=“1”. The power supply controller 213 still blocks the power supply voltage PS3 that is to be applied to the digital demodulation unit 203, on the basis of DTM2=“0”. The clock controller 215 still disables the digital TV clock signal CLKD on the basis of DTM1=“0”.

When the tuner-on signal TON is “1” and the analog TV mode signals ATM1 and ATM2 are both “1”, the states of the RF tuner 201, analog demodulation unit 202 and analog TV processing unit 204, which are necessary for the analog TV processing in the TV tuner/capture unit 112, are changed to operable states. In contrast, the digital demodulation unit 203 and digital TV processing unit 205, which are unnecessary for the analog TV processing in the unit 112 (or which are unnecessary for the execution of the TV application 50 in the analog TV mode), are still set in the power-saving state (nonoperable state) since the digital TV mode signals DTM1 and DTM2 are both “0”. The power-saving state therefore prevents the circuits unnecessary for the analog TV processing from consuming power.

The TV tuner/capture unit 112 under the above condition performs the main processing (block S22 in FIG. 6) of the analog TV processing as follows. First, the RF tuner unit 201 converts an RF signal 301 into an IF signal 302. The IF signal 302 is transmitted to the analog demodulation unit 202 and digital demodulation unit 203. The unit 202 is set in an operable state and the unit 203 is set in a power-saving state (nonoperable state). Thus, the unit 203 has impedance that is higher than that of the unit 202 and the unit 202 is connected at low impedance to the RF tuner unit 201. Of the units 202 and 203, only the unit 202 functions to demodulate the IF signal 302. The unit 202 outputs a video composite signal 303 and a sound IF signal 304.

The video composite signal 303 and sound IF signal 304 are supplied to the analog TV processing unit 204 that is in an operable state. The digital TV processing unit 205 is in a power-saving state (nonoperable state). The unit 204 performs a video decoding process and a sound decoding process for decoding the video composite signal 303 and sound IF signal 304 to generate digital vide data of ITU-656 format and digital audio data of I2S format, respectively. The unit 204 compresses and encodes the digital video data and digital audio data into an AV stream, and outputs the AV stream as analog TV data 306.

The selector 206b in the bus IF unit 206 selects the analog TV data 306 in the analog TV mode where b1=“1” and b2=“0”. The bus converter 206c in the unit 206 converts the analog TV data 306 into system bus data of a format that conforms to the PCI bus (system bus) 21. The bus converter 206c transfers the system bus data to the system logic 100 via the bus connector 30 and PCI bus 21 such that the system bus data can be used by the TV application 50.

In the analog TV mode, the digital demodulation unit 203 and digital TV processing unit 205, which are unnecessary for the analog TV processing, are set in the power-saving state (nonoperable state) as described above. The power-saving state therefore prevents the units 203 and 205 from consuming undesired power.

The system bus data transferred to the system logic 100 is supplied to the TV application 50 that is to be executed by the CPU 101, and decoded into video data and sound data by the application 50. The video data is improved in quality by the video processor 108 and displayed on, for example, the LCD 17. The sound data is output to, for example, the speakers 18A and 18B or an external 5.1-channel speaker system. The system bus data can be transferred to the HDD 121 and recorded therein by executing the application 50 according to a user's instruction.

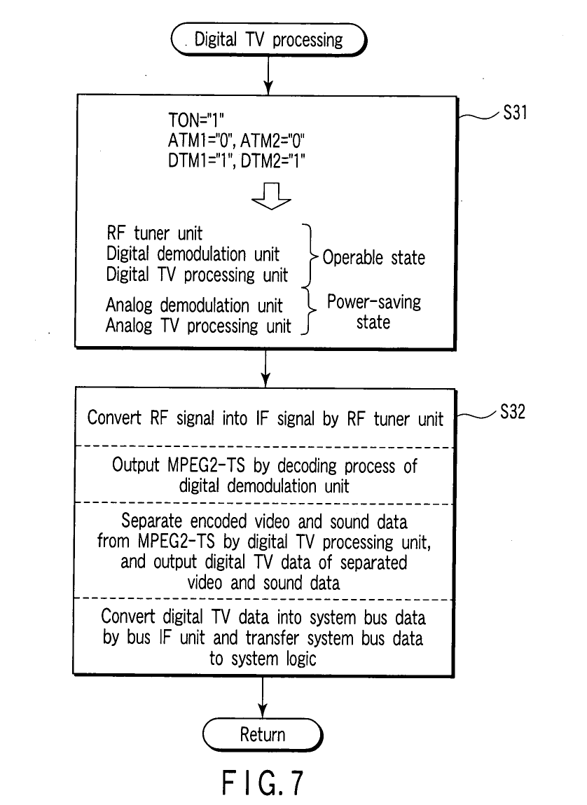

The digital TV processing of block S11 will be described with reference to the flowchart shown in FIG. 7. First, the power-saving controller 216 sets the states of the tuner-on signal TON, analog TV mode signals ATM1 and ATM2 and digital TV mode signals DTM1 and DTM2 as follows, or as shown in FIG. 4, in accordance with the values of bits b0, b1 and b2 (b0=“1”, b1=“0” and b2=“1”) of the control register 206a (block S31 in FIG. 7):

TON=“1”

ATM1=“0”

ATM2=“0”

DTM1=“1”

DTM2=“1”

Then, the power supply controller 211 turns on the power supply voltage PS1 that is to be applied to the RF tuner unit 201, on the basis of TON=“1”. The power supply controller 213 turns on the power supply voltage PS3 that is to be applied to the digital demodulation unit 203, on the basis of DTM2=“1”. The clock controller 215 enables the digital TV clock signal CLKD on the basis of DTM1=“0”. The power supply controller 212 still blocks the power supply voltage PS2 that is to be applied to the analog demodulation unit 202, on the basis of ATM2 =“0”. The clock controller 214 still disables the analog TV clock signal CLKA on the basis of ATM1=“0”.

When the tuner-on signal TON is “1” and the digital TV mode signals DTM1 and DTM2 are both “1”, the states of the RF tuner 201, digital demodulation unit 203 and digital TV processing unit 205, which are necessary for the digital TV processing in the TV tuner/capture unit 112, are changed to operable states. In contrast, the analog demodulation unit 202 and analog TV processing unit 204, which are unnecessary for the digital TV processing in the unit 112 (or which are unnecessary for the execution of the TV application 50 in the digital TV mode), are still set in the power-saving state (nonoperable state) since the analog TV mode signals ATM1 and ATM2 are both “0”. The power-saving state therefore prevents the circuits unnecessary for the analog TV processing from consuming power.

The TV tuner/capture unit 112 under the above condition performs the main processing (block S32 in FIG. 7) of the digital TV processing as follows. First, the RF tuner unit 201 converts an RF signal 301 into an IF signal 302. The IF signal 302 is transmitted to the analog demodulation unit 202 and digital demodulation unit 203. The unit 202 is set in a power-saving state (nonoperable state) and the unit 203 is set in an operable state. Thus, the unit 202 has impedance that is higher than that of the unit 203 and the unit 203 is connected at low impedance to the RF tuner unit 201. Of the units 202 and 203, only the unit 203 functions to demodulate the IF signal 302. The unit 203 outputs an MPEG2-TS 305.

The MPEG2-TS 305 is supplied to the digital TV processing unit 205 that is in an operable state. The analog TV processing unit 204 is in a power-saving state (nonoperable state). The unit 205 temporarily buffers the MPEG2-TS 305 and separates the encoded video data and sound data from the MPEG2-TS 305. The unit 205 outputs the separated video data and sound data to the bus IF unit 206 as digital TV data 307.

The selector 206b in the bus IF unit 206 selects the digital TV data 307 in the digital TV mode where b1=“0” and b2=“1”. The bus converter 206c in the unit 206 converts the digital TV data 307 into system bus data of a format that conforms to the PCI bus (system bus) 21. The bus converter 206c transfers the system bus data to the system logic 100 via the bus connector 30 and PCI bus 21 such that the system bus data can be used by the TV application 50.

According to the above embodiment, the analog TV data 306 in the analog TV mode and the digital TV data 307 in the digital TV mode are converted into common system bus data by the bus converter 206c of the single bus IF unit 206, and the system bus data is transferred to the system logic 100. In other words, the single bus IF unit 206 can be used for both the analog and digital TV modes. The TV tuner/capture unit 112 can thus be decreased in size, unlike in the case where a bus interface unit is provided for each of the analog and digital TV processing units. Consequently, the TV tuner/capture unit 112 can easily be incorporated in a notebook personal computer such as the personal computer 10.

In the digital TV mode, the analog demodulation unit 202 and analog TV processing unit 204 which are unnecessary for the digital TV processing are set in a power-saving state (nonoperable state), as described above. The power-saving state therefore prevents the analog demodulation unit 202 and analog TV processing unit 204 from consuming undesired power.

The system bus data transferred to the system logic 100 is supplied to the TV application 50 and decoded into video data and sound data by the application 50. The video data is displayed on, for example, the LCD 17, while the sound data is output to, for example, the speakers 18A and 18B.

After that, the TV mode control module 42 of the TV tuner/capture driver 40 monitors an end notification command and a mode designation command from the start/end notification module 51 and TV mode designation module 52 of the TV application 50 (blocks S12 and S6 in FIG. 5B). Assume here that the module 42 detects that the mode designation command designates a mode other than the current mode (block S7 in FIG. 5B), or assume that the module 42 detects that the mode designation command designates a change from the analog TV mode to the digital TV mode or from the digital TV mode to the analog TV mode. The TV mode control module 42 performs the process of block S10 or S8 to change the analog TV mode to the digital TV mode, and vice versa. Accordingly, the digital TV processing (block S11) or the analog TV processing (block S9) is performed.

Assume then that the TV mode control module 42 detects the end notification from the start/end notification module 51 in block S12. The power-saving control module 41 of the TV tuner-capture driver 40 sets bit b0 of the control register 206a to “1” and the TV mode control module 42 sets bit b1 and bit b2 thereof to “0” (block S13 in FIG. 5B). Consequently, bits b0, b1 and 2 of the control register 206a are “1”, “0” and “0”, respectively. The power-saving controller 216 sets the states of the tuner-on signal TON, analog TV mode signals ATM1 and ATM2 and digital TV mode signals DTM1 and DTM2 as shown in FIG. 4 in accordance with bit b0b1b2 (=100) of the control register 206a (block S4 in FIG. 5A). Thus, the TV tuner/capture unit 112 returns to the state which brings the greatest power-saving effect and which is the same as when the TV tuner/capture driver 40 starts.

In the embodiment of the invention, it is one TV tuner/capture unit 112 that is incorporated in the personal computer 10. However, a plurality of TV tuner/capture units, e.g., two TV tuner/capture units can be incorporated in the personal computer 10. If each of the TV tuner/capture units is controlled in the same manner as the TV tuner/capture unit 112 of the above embodiment, its power saving can be achieved. Assume that one of the TV tuner/capture units is used for viewing and hearing a broadcast program in analog TV mode and the other is used for recording it in digital TV mode. In the one of the TV tuner/capture units, the digital demodulation unit 203 and digital TV processing unit 205 have only to be set in a power-saving state while bit b0b1b2 of the control register 206a is “110”. In the other TV tuner/capture unit, the analog demodulation unit 202 and analog TV processing unit 204 have only to be set in a power-saving state while bit b0b1b2 of the control register 206a is “101”.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from spirit of the inventions. The accompanying claims and their equivalents are intended to cover such forms or modifications as would fall within the scope and sprit of the inventions.

What is claimed is:

1. An information processing apparatus which has a bus used to transfer various items of data including video data reproduced by execution of a television application program that supports both an analog television mode and a digital television mode and which allows data transferred via the bus to be displayed on a display device, the apparatus comprising:
a receiving unit configured to receive both analog broadcast program data and digital broadcast program data, the receiving unit including:
a digital/analog shared tuner unit configured to convert a radio-frequency signal, which is generated by mixing an analog-modulated television signal and a digital-modulated television signal together, into an intermediate frequency signal;
an analog demodulation unit configured to demodulate the intermediate frequency signal output from the tuner unit and generate data of a first format in the analog television mode;
a digital demodulation unit configured to demodulate the intermediate frequency signal output from the tuner unit and generate data of a second format in the digital television mode;
an analog television processing unit configured to subject the data of the first format to a process proper thereto and output analog television data;
a digital television processing unit configured to subject the data of the second format to a process proper thereto and output digital television data; and
a bus interface unit configured to connect the bus to the analog television processing unit and the digital television processing unit; and
a control unit configured to set a unit that is unnecessary for execution of the television application program in a power-saving state according to an execution state of the television application program, the unit being one of the tuner unit, the analog demodulation unit, the digital demodulation unit, the analog television processing unit, and the digital television processing unit included in the receiving unit.

2. The information processing apparatus according to claim 1, wherein the control unit starts when the information processing apparatus is initialized, sets the tuner unit, the analog demodulation unit, the digital demodulation unit, the analog television processing unit, and the digital television processing unit in a power-saving state when the information processing apparatus starts, sets the digital demodulation unit and the digital television processing unit in the power-saving state when the analog television mode is designated by the television application program, and sets the analog demodulation unit and the analog television processing unit in the power-saving state when the digital television mode is designated by the television application program.

3. The information processing apparatus according to claim 2, wherein the receiving unit further includes:
a power-saving controller configured to output a first control signal, a second control signal, a third control signal, a fourth control signal and a fifth control signal in order to set each of the tuner unit, the analog demodulation unit, the digital demodulation unit, the analog television processing unit, and the digital television processing unit in one of an operable state and a power-saving state by the control unit;
a first controller configured to set the tuner unit in one of the operable state and the power-saving state in response to the first control signal;
a second controller configured to set the analog demodulation unit in one of the operable state and the power-saving state in response to the second control signal;
a third controller configured to set the digital demodulation unit in one of the operable state and the power-saving state in response to the third control signal;
a fourth controller configured to set the analog television processing unit in one of the operable state and the power-saving state in response to the fourth control signal; and
a fifth controller configured to set the digital television processing unit in one of the operable state and the power-saving state in response to the fifth control signal.

4. The information processing apparatus according to claim 3, wherein:
the control unit includes a power-saving control module and a television mode control module;
the power-saving control module is configured to set the receiving unit in a power-saving control mode when the information processing apparatus starts;
the television mode control module sets the receiving unit, which is set in the power-saving control mode, in the analog television mode when the analog television mode is designated by the television application program, and sets the receiving unit, which is set in the power-saving control mode, in the digital television mode when the digital television mode is designated by the television application program; and
the power-saving controller sets the first control signal, the second control signal, the third control signal, the fourth control signal and the fifth control signal in a first logic state to designate the power-saving state in a first state where the receiving unit is set in the power-saving control mode and neither in the analog television mode nor in the digital television mode, sets the first control signal, the second control signal and the fourth control signal in a second logic state to designate the operable state and the third control signal and the fifth control signal in the first logic state in a second state where the receiving unit is set in the power-saving control mode and the analog television mode, and sets the first control signal, the third control signal and the fifth control signal in the second logic state and the second control signal and the fourth control signal in the first logic state in a third state where the receiving unit is set in the power-saving control mode and the digital television mode.

5. The information processing apparatus according to claim 3, wherein:
the first controller turns on/off a power supply voltage, which is to be applied to the tuner unit, in response to the first control signal;
the second controller turns on/off a power supply voltage, which is to be applied to the analog demodulation unit, in response to the second control signal; and
the third controller turns on/off a power supply voltage, which is to be applied to the digital demodulation unit, in response to the third control signal.

6. The information processing apparatus according to claim 3, wherein:
the fourth controller masks a clock signal, which is used in the analog television processing unit, in response to the fourth control signal; and
the fifth controller masks a clock signal, which is used in the digital television processing unit, in response to the fifth control signal.

7. The information processing apparatus according to claim 6, wherein the analog television processing unit and the digital television processing unit are included in a single-chip LSI to which a power supply voltage common to the analog television processing unit and the digital television processing unit is applied.

8. The information processing apparatus according to claim 7, wherein:
the analog television processing unit incorporates the fourth controller; and
the digital television processing unit incorporates the fifth controller.

9. The information processing apparatus according to claim 7, wherein:
the LSI further includes the bus interface unit; and
the bus interface unit employs the power supply voltage applied to the LSI as a power supply voltage for the bus interface unit.

10. The information processing apparatus according to claim 1, wherein the bus interface unit converts the analog television data output from the analog television processing unit into data of a format that conforms to the bus in the analog television mode, and converts the digital television data output from the digital television processing unit into data of a format that conforms to the bus in the digital television mode, and the bus interface unit sends the data to the bus.

11. The information processing apparatus according to claim 10, wherein the bus interface unit includes:
a selector which selects the analog television data in the analog television mode and selects the digital television data in the digital television mode; and
a bus converter which converts data selected by the selector into data of a format that conforms to the bus and sends out the data to the bus.

12. An information processing apparatus which supports both an analog television mode and a digital television mode, the information processing apparatus having a bus used to transfer various items of data including video data reproduced in one of the analog television mode and the digital television mode and allowing data transferred via the bus to be displayed on a display device, the apparatus comprising:
a receiving unit configured to receive both analog broadcast program data and digital broadcast program data, the receiving unit including:
a digital/analog shared tuner unit configured to convert a radio-frequency signal, which is generated by mixing an analog-modulated television signal and a digital-modulated television signal together, into an intermediate frequency signal;
an analog demodulation unit configured to demodulate the intermediate frequency signal output from the tuner unit and generate data of a first format in the analog television mode;
a digital demodulation unit configured to demodulate the intermediate frequency signal output from the tuner unit and generate data of a second format in the digital television mode;
an analog television processing unit configured to subject the data of the first format to a process proper thereto and output analog television data;
a digital television processing unit configured to subject the data of the second format to a process proper thereto and output digital television data; and
a bus interface unit configured to connect the bus to the analog television processing unit and the digital television processing unit; and
a control unit configured to start when the information processing apparatus is initialized and control power savings of the receiving unit, the control unit setting the tuner unit, the analog demodulation unit, the digital demodulation unit, the analog television processing unit and the digital television processing unit in a power-saving state when the information processing apparatus starts, setting the digital demodulation unit and the digital television processing unit in the power-saving state in the analog television mode, and setting the analog demodulation unit and the analog television processing unit in the power-saving state in the digital television mode.

13. A method of controlling power savings of a receiving unit included in an information processing apparatus, the receiving unit converting a radio-frequency signal generated by mixing an analog-modulated television signal and a digital-modulated television signal together into an intermediate frequency signal and demodulating the intermediate frequency signal to generate data of a format corresponding to one of an analog television mode and a digital television mode which is designated by an application program, the receiving unit having a plurality of processing units including a bus interface unit, the bus interface unit being set in an operable state by powering on the information processing apparatus and supplying a bus with one of analog television data and digital television data, which is obtained by performing a process proper to the format of the data, the method comprising:
setting the processing units excluding the bus interface in a power-saving state during a period from when the receiving unit is initialized until one of the analog television mode and the digital television mode is designated by the television application program;
detecting that one of the analog television mode and the digital television mode is designated by the television application program;
setting only a processing unit of the processing units excluding the bus interface unit, which is necessary for processing in the analog television mode, in an operable state and setting other processing units in a power-saving state, when the analog television mode is designated; and
setting only a processing unit of the processing units excluding the bus interface unit, which is necessary for processing in the digital television mode, in an operable state and setting other processing units in a power-saving state, when the digital television mode is designated.

14. The method according to claim 13, further comprising:
detecting that the television application program is completed; and
setting the processing units excluding the bus interface unit in the power-saving state when the television application program is completed.
